(19) United States
(12) Patent Application Publication
(10) Pub. No.: US 2012/0238166 A1
(43) Pub. Date: Sep. 20, 2012

(54) COATED WATERPROOF FABRIC

(75) Inventor: Andrew Nasarczyk, Maribyrnong (AU)

(73) Assignee: GALE PACIFIC USA, INC., Altamonte Springs, FL (US)

(21) Appl. No.: 13/421,903

(22) Filed: Mar. 16, 2012

Related U.S. Application Data
(60) Provisional application No. 61/454,123, filed on Mar. 18, 2011.

(51) Int. Cl. B32B 5/02; B05D 3/12; B05D 1/00

(52) U.S. Cl. 442/85; 427/359

(57) ABSTRACT

A coated waterproof fabric including a warp-knitted base fabric formed of first and second yarn types at least one of which is a UV-stabilized high density synthetic yarn, and a low density polymer coating applied to the warp-knitted base fabric through an extrusion process. A method for manufacturing a coated waterproof fabric.

### CROSS-REFERENCE TO RELATED APPLICATION

This application claims priority to U.S. Provisional Application No. 61/454,123 filed Mar. 18, 2011, the contents of which are incorporated by reference herein.

### TECHNICAL FIELD AND BACKGROUND OF THE INVENTION

1. Field of the Invention

The present invention relates generally to the field of coated waterproof fabrics, and more particularly, to a coated waterproof fabric including a warp-knitted base fabric including first and second yarn types at least one of which includes a UV-stabilized high density synthetic yarn, and a low density polymer coating applied to the knitted base through an extrusion process.

2. Background of the Invention

Waterproof fabrics have a wide variety of uses in both heavy-duty commercial and industrial applications, and in lighter weights, in residential-type end user applications. Some of the uses of waterproof fabrics include tarps, tents and coverings for many different types of shelters. To waterproof a fabric, one conventional technique involves laminating a base fabric with a plastic or resin film. This technique can cause both short term and long term problems, as an improperly-applied laminate may leak from the beginning of its use and become progressively delaminated during use as a result of being folded or stretched. Laminates may further deteriorate over time as a result of UV exposure. Thus, the waterproof characteristics of the fabric may be substantially degraded long before the base fabric has reached the end of its useful life.

Accordingly, it would be desirable to provide a coated waterproof fabric that overcomes the short and long term disadvantages of laminated fabrics. Such a fabric should provide enhanced wear and UV resistance both initially and throughout the life of the fabric.

### BRIEF SUMMARY OF THE INVENTION

In one aspect, a coated waterproof fabric is provided herein.

In another aspect, a coated waterproof fabric is provided herein for outdoor use in articles such as tarps, tents, awnings, like structures and other articles.

In yet another aspect, a method of waterproofing a fabric is provided herein.

To achieve the foregoing and other aspects and advantages, in one embodiment a coated waterproof fabric is provided herein including a warp-knitted base fabric formed of first and second yarn types, at least one of the first and second yarns including a UV-stabilized high density synthetic yarn, and wherein a low density polymer coating is applied to the knitted base through an extrusion process.

The at least one of the fist and second yarns may include high density polyethylene. The polymer coating may include polyethylene.

The first and second yarns may be monofilament and tape yarns, respectively.

The yarns may be high density polyethylene with an active UV loading of between about 0.4 and 1 percent.

The base fabric may have a weight of between about 200 and 380 g/m². The base fabric may be knitted with a lock stitch pattern with a 3 bar, 6 gauge knit construction.

According to another embodiment of the invention, the coating may be applied to the knitted base fabric according to a method including the steps of applying the coating in the form of a viscous liquid and subsequently applying a gloss roller to the fabric and the applied coating. The step of applying the gloss roller may further include the step of applying a chilled roller to solidify the coating on the fabric with a gloss finish with enhanced adhesion between the coating and the fabric. The coating may be extruded onto the fabric.

The coating may have a thickness of about 100 microns.

According to further embodiments of the invention, the coating may include a material applied to the knitted-base fabric according to a method selected from the group consisting of applying a high-solids viscous liquid, blowing the coating onto the fabric, and casting a film onto the fabric.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

Some of the aspects of the invention have been set forth above. Other features, aspects and advantages of the present invention are better understood when the following detailed description of the invention is read with reference to the accompanying drawings, in which:

FIG. 1 is a photograph of one face of a coated waterproof fabric according to an embodiment of the invention;

FIG. 2 is a photograph of another face of a coated waterproof fabric according to an embodiment of the invention; and

FIG. 3 is a stitch diagram of the fabric according to an embodiment of the invention.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

Provided herein are embodiments of coated waterproof fabrics and methods for manufacturing the same. Such coated waterproof fabrics are particularly well suited for use in tarps, tents and shelter coverings, although their use in envisioned in other applications in requiring waterproof fabrics.

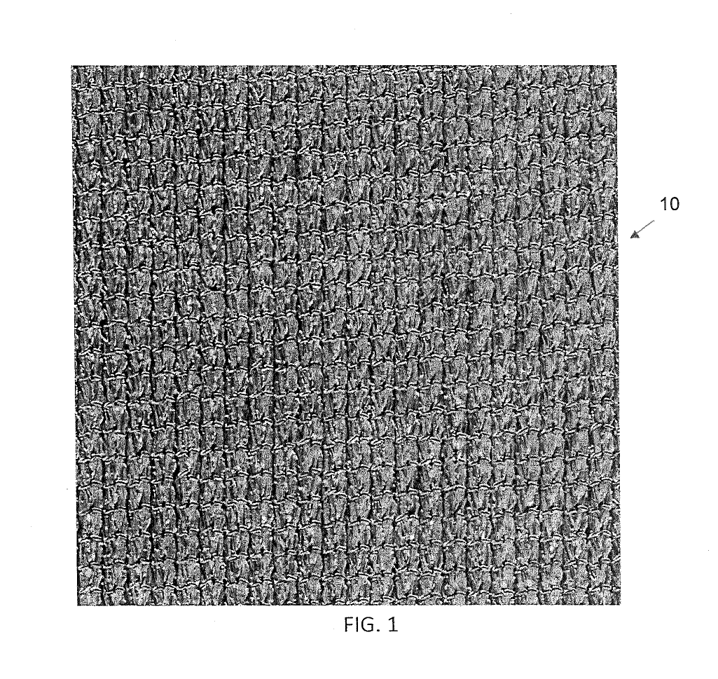

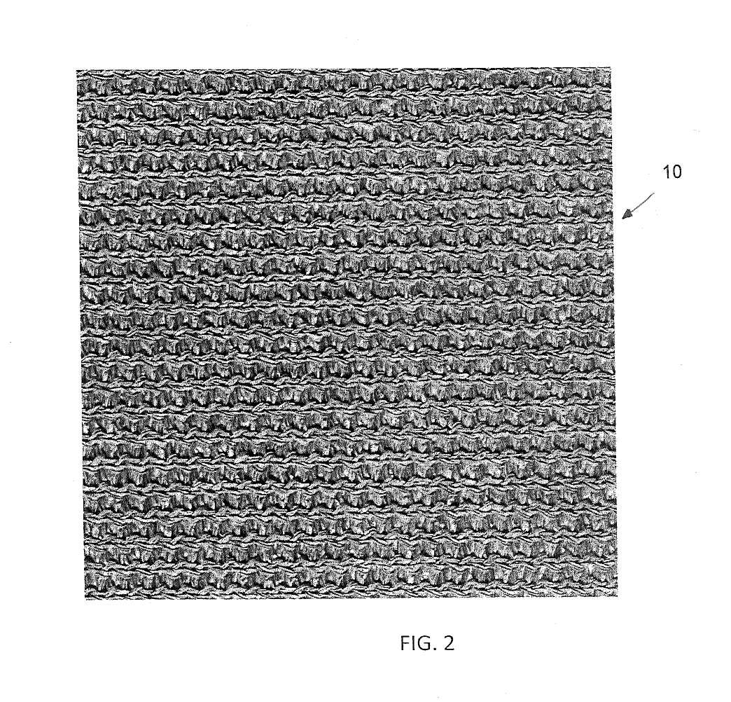

Referring now specifically to the drawings, a coated waterproof fabric according to the present invention is shown generally in FIGS. 1 and 2 at reference numeral 10. According to a preferred embodiment of the invention, the base fabric 10 is a 340 g/m² warp-knitted fabric including both monofilament and tape yarns. Warp knitting is used in the broad sense herein to refer to the family of knitting methods in which the yarn “zigzags” along the length of the fabric, i.e., following adjacent columns (“wales”) of knitting. Such constructions are run-resistant and have a high degree of dimensional stability compared to many woven fabrics and weft knitted fabrics, and thus are ideal for applications requiring durable fabrics.

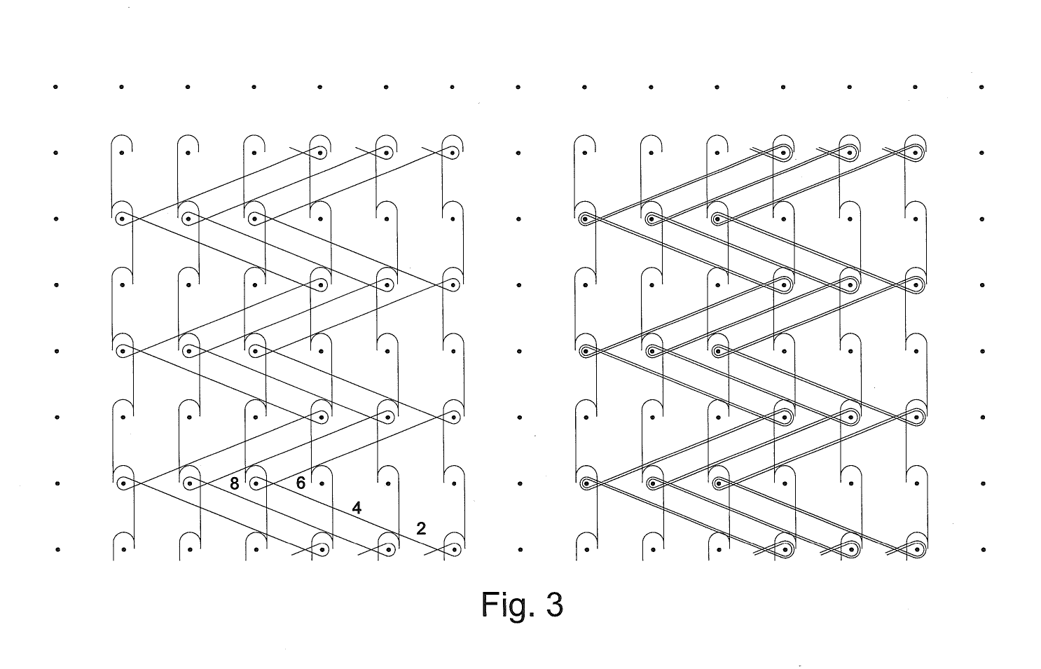

In a preferred embodiment, the fabric yarns are high density polyethylene (HDPE) yarns that are UV-stabilized (preferably HALS) with active UV loading of between about 0.4 and 1 percent. Other embodiments of the base fabric may preferably range between about 200 and 380 g/m², although there is no theoretical limit on the possible weights, which may be determined based on the end use. The fabric may be knitted with a lock stitch pattern, 3 bar and 6 gauge knit construction. An exemplary stitch pattern is shown graphically in FIG. 3.

The lock stitch provides dimensional re-enforcement and tensile strength to the fabric structure. An exemplary width of the fabric may be about 2.80 m, but may vary from about 1.5 m to 3.2 m. As with the weight, there is no theoretical limit to the width.

The fabric is coated with an extrusion coating to render the fabric waterproof. One preferred embodiment of the coating is a UV-stabilized low density polyethylene (LDPE) coating applied to the knitted base fabric through an extrusion coating process. Other coating materials may be used. Extrusion coating may include using a high-solids viscous liquid, blown or cast film process to coat an additional layer onto the preformed knitted fabric. Typical UV active levels in the coating (preferably HALS) can vary from about 0.4 to 1.0 percent active loading. Typical coating thickness may be about 100 microns, though the coating thickness can preferably range from about 60 to 150 microns, or an even greater range depending upon the application. The coating is preferably applied at a high temperature up to about 300 degrees C., which has been determined to be optimal for maximum adhesion properties.

Subsequent to the application of the UV-stabilized low density polyethylene (LDPE) coating, a gloss chilled roller may then be used to form an even, high quality surface finish. In general, using a gloss chill roller improves gloss, provides a high level of coating adhesion, increases impact strength and tends to lower orientation shrinkage. A preferred finished width is about 2.70 m, but may vary from about 1.5 m to 3.20 m, or more.

The resulting preferred fabric is suitable as a component of, for example, small scale architectural structures requiring a waterproof membrane. The high levels of coating adhesion allow for hot wedge and hot air welding. The high UV loading allows for a minimum of 5 year outdoor exposure. Other fabric weights and densities may be suitable for heavy-duty industrial and commercial applications.

An improved coated waterproof fabric is described above. Various details of the invention may be changed without departing from the scope of the invention. Furthermore, the foregoing description of the preferred embodiment of the invention and best mode for practicing the invention are provided for the purpose of illustration only and not for the purpose of limitation, the invention being defined by the claims.

What is claimed is:

1. A coated waterproof fabric, comprising:
(a) a warp-knitted base fabric formed of first and second yarn types;
(b) at least one of the first and second yarn types comprising a UV-stabilized high density synthetic yarn; and
(c) a low density polymer coating applied to the warp-knitted base fabric through an extrusion process.

2. The coated waterproof fabric according to claim 1, wherein the at least one of the first and second yarn types is a high density polyethylene yarn.

3. The coated waterproof fabric according to claim 1, wherein the low density polymer coating comprises polyethylene.

4. The coated waterproof fabric according to claim 1, wherein the first yarn type is a monofilament yarn and the second yarn type is a tape yarn.

5. The coated waterproof fabric according to claim 1, wherein the first and second yarn types are high density polyethylene with an active UV loading of between about 0.4 and 1 percent.

6. The coated waterproof fabric according to claim 1, wherein the warp-knitted base fabric has a weight between about 200 and 380 g/m².

7. The coated waterproof fabric according to claim 1, wherein the warp-knitted base fabric is knitted with a lock stitch pattern with a 3 bar, 6 gauge knit construction.

8. The coated waterproof fabric according to claim 1, wherein the low density polymer coating is applied according to a method comprising the steps of applying the low density polymer coating in the form of a viscous liquid and subsequently applying a gloss roller to the fabric and the applied low density polymer coating.

9. The coated waterproof fabric according to claim 8, wherein the step of applying a gloss roller includes the step of applying a chilled roller to solidify the low density polymer coating on the fabric with a gloss finish with enhanced adhesion between the low density polymer coating and the fabric.

10. The coated waterproof fabric according to claim 1, wherein the low density polymer coating has a thickness of about 100 microns.

11. The coated waterproof fabric according to claim 1, wherein the low density polymer coating is applied according to a method selected from the group consisting of applying a high-solids viscous liquid, blow coating onto the warp-knitted base fabric, and casting a film onto the warp-knitted base fabric.

12. A method of waterproofing a fabric, comprising:
(a) providing a warp-knitted base fabric formed of first and second yarn types, at least one of the first and second yarn types comprising a UV-stabilized high density synthetic yarn;
(b) applying a low density polymer coating to the warp-knitted base fabric through an extrusion process comprising applying the low density polymer coating in the form of a viscous liquid; and
(c) applying a gloss roller to the fabric and the applied low density polymer coating.

13. The method of waterproofing a fabric according to claim 12, wherein the step of applying a gloss roller includes the step of applying a chill roller to solidify the low density polymer coating on the fabric with a gloss finish with enhanced adhesion between the low density polymer coating and the fabric.

14. The method of waterproofing a fabric according to claim 12, wherein the extrusion process is selected from the group consisting of applying a high-solids viscous liquid, blow coating onto the warp-knitted base fabric, and casting a film onto the warp-knitted base fabric.
